(19) United States
(12) Patent Application Publication
(10) Pub. No.: US 2017/0244229 A1
(43) Pub. Date: Aug. 24, 2017

(54) WEATHERPROOF JUNCTION BOX

(71) Applicant: Jinxing Yang, Roland Heights, CA (US)

(72) Inventor: Jinxing Yang, Roland Heights, CA (US)

(21) Appl. No.: 15/442,616

(22) Filed: Feb. 24, 2017

Related U.S. Application Data
(60) Provisional application No. 62/299,465, filed on Feb. 24, 2016.

(51) Int. Cl. H02G 3/08; H02G 3/18; H02G 3/14

(52) U.S. Cl. CPC H02G 3/088; H02G 3/14; H02G 3/18

(57) ABSTRACT

A weatherproof electrical box assembly may include a cover portion, a center portion and a bottom portion. The cover portion and bottom portion are configured to be integrated as a single piece. The cover portion is removably attached to one side of the center portion, and an adapter plate is removably secured to a recessed portion of the center portion. In one embodiment, the back wall of the bottom portion includes one or more bottom openings for receiving and attaching an electrical wire to an electrical component installed in the bottom portion. One advantage of securing the center portion onto the outer edges of the bottom portion, is that electrical components are thereby recessed in the bottom portion and not positioned adjacent the cover portion. As a result, electrical components may be further protected from any moisture accumulating on the inside cover area of the cover portion.

### CROSS-REFERENCE TO RELATED APPLICATIONS

This application claims priority under 35 U.S.C. §119 (e) to U.S. Provisional Patent Application Ser. No. 62/299,465, filed on Feb. 24, 2016, the entire contents of which are hereby incorporated by reference.

### FIELD OF THE INVENTION

The present invention relates to a weatherproof junction box, and more particularly to a weatherproof junction box that is integrated with the base connector box as a single piece component.

### BACKGROUND OF THE INVENTION

Electrical junction boxes are used for a variety of applications wherein it is necessary to provide a termination point for electrical wires for splicing or connection to an electrical component. An electrical box is rigidly mounted on or in a wall in such locations to conveniently locate an electrical component. Depending on the application and location, electrical boxes can be mounted either in a horizontal or vertical orientation. Once mounted, the wires installed and connected to the electrical component therein, the box is closed with a face plate. The face plate must be chosen to match the installed electrical component, and covers the top opening of the connector box, thus preventing any damage to the components mounted in the box or accidental contact with live electrical wires.

Electrical junction boxes are also used in major installations in underground construction, where large cables are joined for high voltage lines. In such cases, the junction boxes are many times the size of the above type and may, for example, be 2′ to 4′ in diameter and 1′ to 4′ high. In the latter case, the construction and structural characteristics required for such junction boxes are significantly different than the small residential or like installations. Where such junction boxes are used exteriorly, they may be buried in the ground or mounted on a slab construction which is subsequently covered with earth, sand or the like. In addition to other factors, such junction boxes must obviously meet requirements for exposure to outdoor criteria e.g. water resistance, etc.

Typically, such installations can include an outdoor receptacle to provide electricity for lighting, power tools or appliances. When used in a location where the connector box will be exposed to water, it is necessary to provide for structure to ensure that water does not enter the box and thereby damage the components therein or cause a “short circuit”. An effective way to prevent water from entering an electrical box is to provide a cover for the faceplate thus providing a weatherproof seal.

U.S. Pat. No. 7,235,740 to Dinh discloses a weatherproof electrical outlet box assembly for shielding and protecting electrical components from moisture comprising a faceplate for attaching to an outlet box as shown in FIG. 1. The faceplate is substantially planar, and perimetrically bounded by a substantially rectangular side edge. The faceplate has at least one aperture for receiving an electrical component and includes a first hinge socket and a second hinge socket extending respectively from the side edge in substantially orthogonal orientation. However, the weatherproof electrical outlet box assembly disclosed by Dinh is a “cover” or a “shell” that needs to be connected with a connector box, which actually places a burden for the user to use the weatherproof outlet box. Therefore, there remains a need for a new and improved design to integrate the weatherproof outlet box with the base connector box to overcome the problems stated above.

### SUMMARY OF THE INVENTION

In one aspect, a weatherproof electrical box assembly may include a cover portion, a center portion and a bottom portion. The cover portion is removably attached to one side of the center portion, and a plurality of adapter plates that are removably and pivotally secured to a recessed portion of the center portion. It is important to note that the cover portion along with the center portion and bottom portion in the present invention are configured to be integrated as a single unit, so the user does not have to bother to engage the cover portion with base connector box as described in the prior arts.

The bottom portion of the present invention is a generally rectangular box-like member that includes a generally flat back wall with a continuous sidewall member upstanding therefrom. The sidewall member includes a pair of oppositely disposed end wall portions, and a pair of oppositely disposed sidewall portions. The front edges of the end wall portions and sidewall portions preferably define a generally planar opening for the bottom portion.

The back wall of the bottom portion includes one or more bottom openings for receiving and attaching an electrical wire to an electrical component installed in the bottom portion. In one embodiment, the bottom portion includes one or more V-shaped slot that also may be adapted to receive electrical wires for attachment to electrical components positioned in the bottom portion. It will be appreciated by one skilled in the art that one or more bottom openings and V-shaped slots may be included on the bottom portion.

In one embodiment, the center portion is a generally rectangular member having a substantially planar rectangular top surface that is perimetrically bounded by an outer wall. The outer wall of the center portion is of dimensions suitable for attaching onto an outer edge of the bottom portion. The center portion includes one or more openings for attaching an electronic component to the center portion. For example, in one embodiment, openings provided on the center portion are adapted to accept a screw to fasten an electronic component to the center portion. Preferably, the electronic component lies on top of the center portion. Afterwards an adapter plate is configured to cover both the electrical component and opening(s) of the center portion in the normal fashion.

One advantage of securing the center portion onto the outer edges of the bottom portion is that electrical components are thereby recessed in the bottom portion and not positioned adjacent the cover portion. As a result, electrical components may be further protected from any moisture accumulating on the inside cover area of the cover portion. Of course, it will be appreciated by one skilled in the art that other techniques may be used to secure the center portion onto the edges of the bottom portion. For example, the center portion may be secured to an internal portion of the bottom portion via screws or via incorporating mechanical structure located on both the plate and the internal wall of the box.

The center portion of the present invention is configured to accommodate any number of electrical components. For example, the center portion can accommodate a single duplex receptacle mounted to a threaded opening. Of course, it will be appreciated by one skilled in the art that the center portion can also accommodate a variety of different components including GFCI receptacles or switches secured atop the center portion. To finish installation, the adapter plate is configured to cover the electrical component in the usual manner.

The cover portion of the present invention is a generally rectangular box-like member having a substantially planar rectangular inner surface that is perimetrically bounded by an outer wall. The outer wall may include four substantially planar side walls having two sets of substantially parallel sides. The outer wall extends around and helps define inner surface and includes an outwardly flanged rim extending from an end thereof. Preferably, the rim is integrally formed on the cover portion as a single piece component and operates to channel away any water that may fall on the cover portion when the cover portion is in the closed position.

Preferably, the outer wall of the cover portion may include a plurality of vertical cover hinge pins and horizontal cover hinge pins for pivotal engagement with the vertical hinge socket and the horizontal hinge socket of the center portion, respectively. By mounting the vertical hinge socket, the vertical cover hinge pin can be rotatably engaged to the hinge socket. The cover portion can thereby be pivoted to rotate into an open or closed position.

Comparing with the conventional weatherproof box, the present invention is advantageous because the cover portion and the bottom portion are integrated as a single piece so that the user does not spend extra effort to engage the cover portion with the bottom portion as described in the prior arts. Furthermore, the center portion is received inside the weatherproof box and the adapter plates can be disposed thereon to protect and accommodate different configurations of electrical wires, cables and/or components.

### BRIEF DESCRIPTION OF THE DRAWINGS

FIG. 1 illustrates a prior art disclosing an electrical connector box cover and attached faceplate in a horizontal position, the cover and faceplate being in a closed position.

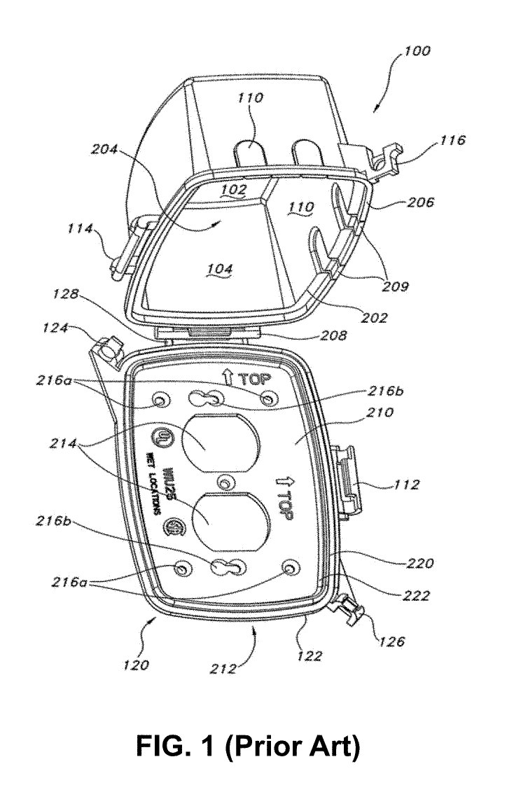

FIG. 2 illustrates a perspective view of the weatherproof junction box in the present invention.

FIG. 3 is a schematic view of the weatherproof junction box in the present invention when the cover portion is opened.

FIG. 4 is a schematic view of the adapter plates of the weatherproof junction box in the present invention.

FIG. 5 is a schematic view of the cover portion having a plurality of vertical cover hinge pins and horizontal cover hinge pins for pivotal engagement with the vertical hinge socket and the horizontal hinge socket of the center portion.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

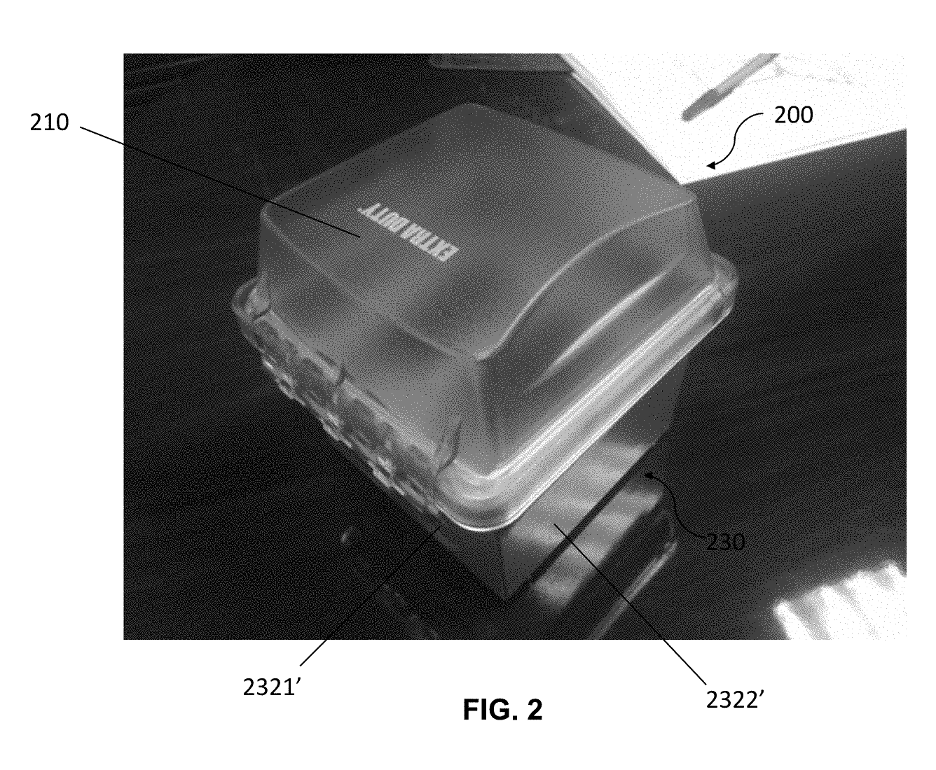

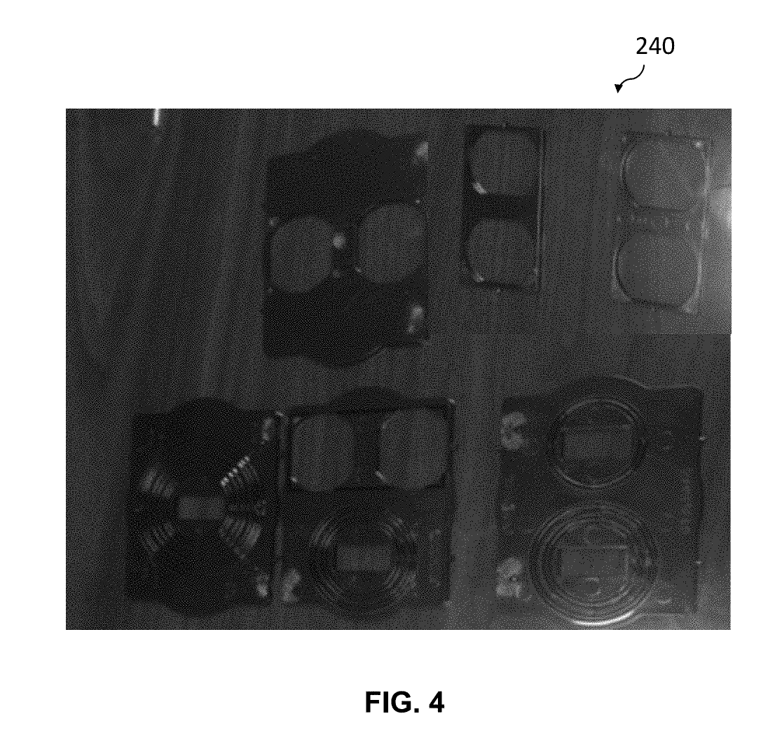

In one aspect, referring to FIGS. 2-4, a weatherproof electrical box assembly 200 may include a cover portion 210, a center portion 220 and a bottom portion 230. The cover portion 210 is removably and pivotally attached to one side of the center portion 220, and an adapter plate 240 can be removably secured to a recessed portion 222 of the center portion 220. It is important to note that the cover portion 210 along with the center portion 220 and bottom portion 230 in the present invention are configured to be integrated as a single unit when in use, so the user does not have to bother to engage the cover portion with base connector box as described in the prior arts.

The bottom portion 230 of the present invention is a generally rectangular box-like member that includes a generally flat back wall 231 with a continuous sidewall member 232 upstanding therefrom. The sidewall member 232 includes a pair of oppositely disposed end wall portions 2321 and 2321′, and a pair of oppositely disposed sidewall portions 2322 and 2322′. The front edges of the end wall portions 231, 231′ and sidewall portions 232, 232′ preferably define a generally planar opening and a receiving space for the bottom portion 230.

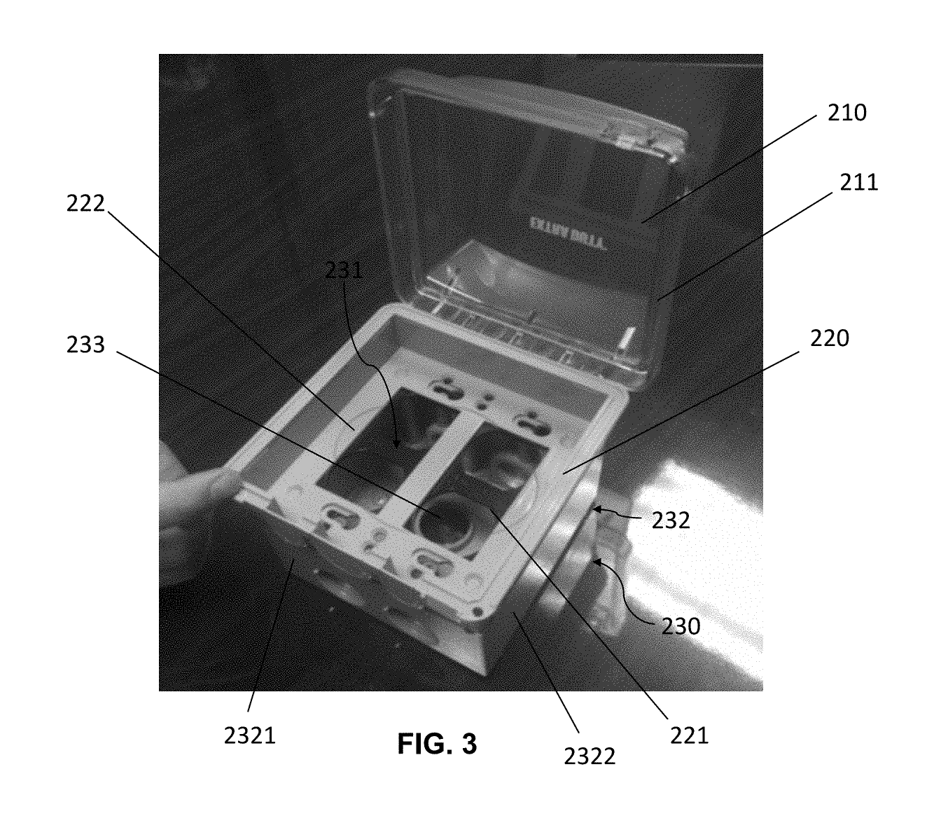

As shown in FIG. 3, the back wall 231 of the bottom portion 230 includes one or more bottom openings 233 for receiving and attaching an electrical wire to an electrical component installed in the bottom portion 230. In one embodiment, the bottom portion 230 includes one or more V-shaped slot that also may be adapted to receive electrical wires for attachment to electrical components positioned in the bottom portion 230. It will be appreciated by one skilled in the art that one or more bottom openings and V-shaped slots may be included on the bottom portion 230.

Still referring to FIG. 3, in one embodiment, the center portion 220 is a generally rectangular member having a substantially planar rectangular top surface that is perimetrically bounded by an outer wall. The outer wall of the center portion 220 is of dimensions suitable for attaching onto an outer edge of the opening of the bottom portion 230. As shown in FIG. 3, the center portion 220 includes one or more openings 221 for attaching an electronic component (not shown) to the center portion 220. For example, in one embodiment, openings 221 are provided on the center portion 220 that are adapted to accept a screw to fasten an electronic component to the center portion 220. Preferably, the electronic component lies on top of the center portion 220. Afterwards an adapter plate 240 is configured to cover both the electrical component and opening(s) of the center portion 220 in the normal fashion.

One advantage of securing the center portion 220 onto the outer edges of the bottom portion 230 is that electrical components are thereby recessed in the bottom portion 230 and not positioned adjacent the cover portion 210. As a result, electrical components may be further protected from any moisture accumulating on the inside cover area of the cover portion 210. Of course, it will be appreciated by one skilled in the art that other techniques may be used to secure the center portion 220 onto the edges of the bottom portion 230. For example, the center portion 220 may be secured to an internal portion of the bottom portion 230 via screws or via incorporating mechanical structure located on both the plate and the internal wall of the box.

The center portion 220 of the present invention is configured to accommodate any number of electrical components. For example, the center portion 220 can accommodate a single duplex receptacle mounted to a threaded opening. Of course, it will be appreciated by one skilled in the art that the center portion 220 can also accommodate a variety of different components including GFCI receptacles or switches secured atop the center portion 220. To finish installation, the adapter plate 240 is configured to cover the electrical component in the usual manner.

The cover portion 210 of the present invention is a generally rectangular box-like member having a substantially planar rectangular inner surface that is perimetrically bounded by an outer wall 211. As shown in FIGS. 2 and 3, the outer wall 211 may include four substantially planar side walls having two sets of substantially parallel sides. The outer wall extends around and helps define inner surface and includes an outwardly flanged rim extending from an end thereof. Preferably, the rim is integrally formed on the cover portion 210 as a single piece component and operates to channel away any water that may fall on the cover portion 210 when the cover portion 210 is in the closed position.

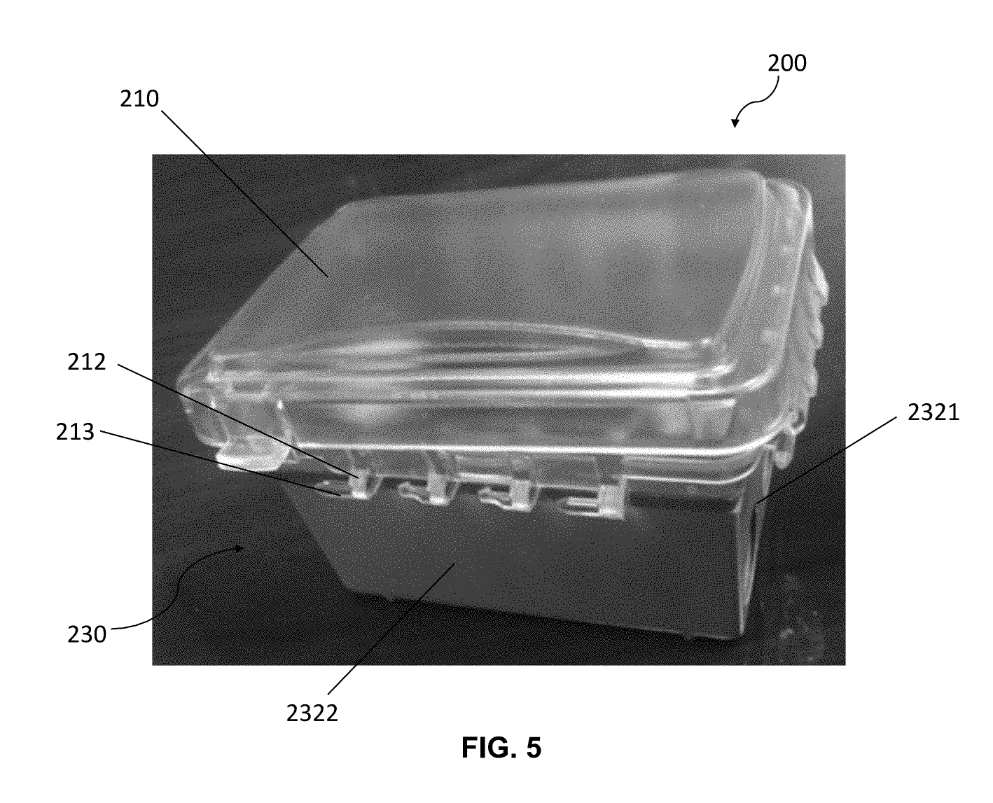

Preferably, as shown in FIG. 5, the outer wall of the cover portion 210 may include a plurality of vertical cover hinge pins 212 and horizontal cover hinge pins 213 for pivotal engagement with the vertical hinge socket and the horizontal hinge socket of the center portion 220, respectively. By mounting the vertical hinge socket, the vertical cover hinge pin can be rotatably engaged to the hinge socket. The cover portion 210 can thereby be pivoted to rotate into an open or closed position.

Comparing with the conventional weatherproof box, the present invention is advantageous because the cover portion 210 along with the center portion 220 and the bottom portion 230 are configured to be integrated as a single piece so that the user does not spend extra effort to engage the cover portion 210 with the bottom portion 230 as described in the prior arts. Furthermore, the center portion 220 is received inside the weatherproof box and the adapter plates 240 can be disposed thereon to protect and accommodate different configurations of electrical wires, cables and/or components.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A weatherproof electrical box assembly comprising
a bottom portion having flat back wall with a continuous sidewall member upstanding therefrom; the sidewall member having a pair of oppositely disposed end wall portions and a pair of oppositely disposed sidewall portions to define a planar bottom opening and receiving space for the bottom portion;
a center portion having a substantially planar rectangular top surface that is perimetrically bounded by an outer wall with dimensions suitable for attaching onto an outer edge of the opening of the bottom portion; and
a cover portion removably and pivotally attached to one side of the center portion,
wherein the cover portion along with the center portion and bottom portion are configured to be integrated as a single unit to better protect the electric component and cables received in the receiving space of the bottom portion.

2. The weatherproof electrical box assembly of claim 1, wherein an adapter plate is configured to be removably secured onto a recessed portion of the center portion.

3. The weatherproof electrical box assembly of claim 1, wherein the back wall of the bottom portion includes one or more bottom openings for receiving and attaching an electrical wire to an electrical component installed in the bottom portion.

4. The weatherproof electrical box assembly of claim 1, wherein the center portion includes one or more openings for attaching an electronic component to the center portion.

5. The weatherproof electrical box assembly of claim 4, wherein the adapter plate is configured to cover both the electrical component and opening(s) of the center portion to protect the electrical components from any moisture accumulating near the cover portion.

6. The weatherproof electrical box assembly of claim 1, wherein the cover portion has a substantially planar rectangular inner surface that is perimetrically bounded by an outer wall.

7. The weatherproof electrical box assembly of claim 6, wherein the outer wall of the cover portion includes a plurality of vertical cover hinge pins and horizontal cover hinge pins for pivotal engagement with the vertical hinge socket and the horizontal hinge socket of the center portion, respectively
